(19) United States
(12) Patent Application Publication
(10) Pub. No.: US 2008/0142757 A1
(43) Pub. Date: Jun. 19, 2008

(54) ALLOYED NANOPHENES

(75) Inventor: DAVID HERBERT ROACH, HOCKESSIN, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DUPONT DE NEMOURS AND COMPANY, WILMINGTON, DE (US)

(21) Appl. No.: 11/610,305

(22) Filed: Dec. 13, 2006

(51) Int. Cl. C01B 31/06; C09K 3/00

(52) U.S. Cl. 252/182.34; 423/364

(57) ABSTRACT

Alloyed nanophenes, comprising carbon, nitrogen, and a Group III element other than boron, are provided. The alloyed nanophenes are useful, for example, as miniature electronic components, such as wires, coils, schottky barriers, diodes, inductors, memory elements, and other circuit devices and elements.

### FIELD OF THE INVENTION

The invention relates to alloyed nanophenes, more particularly to alloyed nanophenes comprising carbon, nitrogen, and a Group III element other than boron.

### BACKGROUND OF THE INVENTION

Nanophenes have one or more single layer arrays or networks of a predominant atom, typically carbon, although up to 50 percent of the predominant atom can be substituted by one or more other atoms. Nanophenes can be functionalized or otherwise reacted to other chemical species. Representative nanophenes include nanotubes; nanohorns (nanotubes having one closed end); and fullerenes, such as, for example, C₆₀ fullerenes, C₇₀ fullerenes, C_{76/78} fullerenes, or C₈₄ fullerenes.

The nanophene layer (or for multiwalled nanophenes, each layer) will tend to curl or otherwise orient in a spherical, tubular, or cornucopia type pattern. In considering a nanophene structure, two axes or directions are noteworthy: (i) the traverse or “y” direction perpendicular to the layer(s); and (ii) the axial or “x” direction parallel to the layer(s) (and perpendicular to the y direction). Nanophenes have an average length in the y direction of less than 100 nanometers. The x direction length of a nanophene can be virtually any length, at least theoretically, but typically is less than a millimeter.

U.S. Pat. No. 6,231,980 discloses nanotubes and nanoparticles having stoichiometries of BₓC_{y}N_{z}, where x, y, and z are integers including zero where no more than one of x, y, and z are zero for a given stoichiometry.

### SUMMARY OF THE INVENTION

One aspect of this invention is an alloyed nanophene having a stoichiometry of C₁₋ₓNₓZ_{y}; wherein Z is selected from aluminum, gallium, and indium; and further wherein 0.05<x<0.2 and 0<y<0.2.

In another aspect of the invention, the inventive alloyed nanophenes can further comprise dopant material. Preferably, the dopant material is selected from carbon, nitrogen, aluminum, silicon, phosphorus, beryllium, oxygen, lithium, sodium, potassium, rubidium, cesium, francium, osmium tetroxide, and mixtures thereof. The nanophene can also be substituted with methyl or butyl groups.

### DETAILED DESCRIPTION

Applicants specifically incorporate herein by reference in their entirety all documents cited in this disclosure. Applicants also incorporate by reference in its entirety the co-owned and concurrently filed application entitled “Composition Containing Nanophene Moieties” (Attorney Docket # CL 2776).

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “alloyed nanophene” as used herein means a composition comprising one or more single layer arrays or networks of a predominant atom, typically carbon, although up to 50 percent of the dominant atom can be substituted with one or more other atoms. Nanophenes can also be functionalized or otherwise reacted to other chemical species. Representative nanophenes include nanotubes; nanohorns; and fullerenes such as, for example, C₆₀ fullerenes, C₇₀ fullerenes, C_{76/78} fullerenes, or C₈₄ fullerenes. Nanotubes can be single-walled nanotubes (SWNT) or multi-walled nanotubes (MWNT). Nanohorns can be single-walled nanohorns or multi-walled nanohorns.

One aspect of the invention is alloyed nanophenes comprising carbon, nitrogen, and a Group III element other than boron. Inventive alloyed nanophenes having crystalline walls can be formulated to comprise a variety of stoichiometries of C₁₋ₓNₓZ_{y}; wherein Z is selected from one or more of aluminum, gallium, and indium; and further wherein 0.05<x<0.2 and 0<y<0.2.

Synthesis of the inventive alloyed nanophenes can be carried out in accordance with methods and instruments known in the art such as those disclosed, for example, in U.S. Pat. No. 6,063,243; U.S. Pat. No. 6,231,980; and Weng-Sieh et al., Phys. Rev. B 51:11229-32 (1995). A number of different electrode types, arc currents, and gas pressure configurations can produce favorable results. In principle, any technique used to make nanotubes can be used to make alloyed nanophenes. Suitable techniques include laser vaporization and chemical vapor deposition routes in addition to the arc discharge method discussed above. In these techniques, the alloy material is first in a vapor form and is then allowed to cool so that the atoms can condense together to form a nanophene. It is not essential that the alloy material is in the vapor phase at exactly the same time as carbon or nitrogen.

The inventive alloyed nanophenes can be doped with added elements and/or molecules to alter the electronic properties of the alloyed nanophenes. Non-limiting examples of doping elements include carbon, nitrogen, aluminum, silicon, phosphorus, beryllium, oxygen, lithium, sodium, potassium, rubidium, cesium, and francium. A non-limiting example of a doping molecule is osmium tetroxide. Mixtures of elements, mixtures of molecules, and mixtures of elements and molecules are also contemplated as dopant materials. Typically, the concentration of dopant is less than 1%. The nanophene can also be substituted with methyl or butyl groups.

The alloyed nanophenes are useful as miniature electronic components, such as wires, coils, schottky barriers, diodes, inductors, memory elements, and other circuit devices and elements. The alloyed nanophenes are also useful as a coating to protect an item from detection by electromagnetic monitoring techniques like radar. The alloyed nanophenes are additionally useful for their mechanical properties, being comparable in strength and stiffness to the best graphite fibers or carbon nanotubes. The inventive alloyed nanophenes are useful in lubricants and composites.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit, and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope, and concept of the invention as defined by the appended claims.

What we claim is:

1. An alloyed nanophene having a stoichiometry of C₁₋ₓNₓZ_{y}; wherein Z is selected from aluminum, gallium, and indium; and further wherein 0.05<x<0.2 and 0<y<0.2.

2. The alloyed nanophene of claim 1 further comprising a dopant material.

3. The alloyed nanophene of claim 2, wherein the dopant material is selected from the group consisting of carbon, nitrogen, aluminum, silicon, phosphorus, beryllium, oxygen, lithium, sodium, potassium, rubidium, cesium, francium, osmium tetroxide, and mixtures thereof.

4. The alloyed nanophene of claim 1, wherein the alloyed nanophene is a single-walled nanotube, a multi-walled nanotube, a nanohorn, or a fullerene.
